(19) United States
(12) Patent Application Publication
(10) Pub. No.: US 2025/0243832 A1
(43) Pub. Date: Jul. 31, 2025

(54) AIR CLEANER

(71) Applicant: SUZUKI MOTOR CORPORATION, Hamamatsu-shi (JP)

(72) Inventors: Shinichi YAMADA, Hamamatsu-shi (JP); Yusuke OHATA, Hamamatsu-shi (JP); Yoshiaki MATSUURA, Hamamatsu-shi (JP); Koki OKAZAWA, Hamamatsu-shi (JP)

(73) Assignee: SUZUKI MOTOR CORPORATION, Hamamatsu-shi (JP)

(21) Appl. No.: 19/038,165

(22) Filed: Jan. 27, 2025

(30) Foreign Application Priority Data
Jan. 30, 2024 (JP) 2024-011529

(51) Int. Cl. F02M 35/04; F02M 35/024; F02M 35/10; F02M 35/16

(52) U.S. Cl. CPC F02M 35/042; F02M 35/10249; F02M 35/162; F02M 35/024

(57) ABSTRACT

An air cleaner is configured to be installed, together with an electrical component, below a seat of a saddle-type vehicle. The air cleaner includes: a cleaner case including an intake chamber formed therein; and an intake pipe configured to take in air into the intake chamber. The cleaner case includes a support surface configured to support the electrical component from below, and an intake port of the intake pipe is covered from above by the electrical component.

### CROSS-REFERENCE TO RELATED APPLICATIONS

This application is based on and claims priority under 35 USC 119 from Japanese Patent Application No. 2024-011529 filed on Jan. 30, 2024, the contents of which are incorporated herein by reference.

### TECHNICAL FIELD

The present disclosure relates to an air cleaner.

### BACKGROUND ART

JP7263534B describes an air cleaner for a saddle-type vehicle, which is installed under a seat. In the air cleaner, a dirty side of a cleaner case faces rearward and a clean side of the cleaner case faces forward. An intake pipe extends rearward from the dirty side of the cleaner case, and air is taken into the cleaner case from a rear side of the vehicle through the intake pipe. Further, an Engine Control Module (ECM) is installed, as an electrical component, below the seat. The ECM is installed on a bottom surface of a recess portion formed in an upper surface of the cleaner case on the dirty side.

### SUMMARY OF INVENTION

In the air cleaner described in JP7263534B, the intake pipe faces rearward. Consequently, foreign matter such as water droplets and mud stirred up by a rear wheel can easily enter an intake port of the intake pipe. Furthermore, the electrical component such as the ECM is installed on the bottom surface of the recess portion in the cleaner case, which may reduce capacity due to the recess in the cleaner case.

The present disclosure has been made in consideration of the above circumstances, and an object thereof is to provide an air cleaner that can ensure a capacity of a cleaner case while preventing intrusion of foreign matter such as water droplets and mud into the cleaner case.

The present disclosure provides air cleaner configured to be installed, together with an electrical component, below a seat of a saddle-type vehicle, the air cleaner including: a cleaner case including an intake chamber formed therein; and an intake pipe configured to take in air into the intake chamber, in which: the cleaner case includes a support surface configured to support the electrical component from below; and an intake port of the intake pipe is covered from above by the electrical component.

According to the aspect of the air cleaner of the present disclosure, the intake port of the intake pipe is covered by the electrical component, whereby even when foreign matter such as water droplets or mud is stirred up by a rear wheel, it is possible to prevent intrusion of foreign matter from the intake port into the cleaner case. The electrical component is supported on the support surface of the cleaner case above the intake port, and there is no need to reduce a capacity of the cleaner case for storing the electrical component. Therefore, the electrical component and the air cleaner can be appropriately installed below the seat.

### BRIEF DESCRIPTION OF DRAWINGS

The present disclosure will be described in detail based on the following without being limited thereto, wherein:

FIG. 1 is a left side view of a saddle-type vehicle according to an embodiment;

FIG. 2 is a perspective view of the air cleaner and its periphery according to the embodiment;

FIG. 3 is a top view of the air cleaner and its periphery according to the embodiment;

FIG. 4 is a perspective view of the air cleaner of the embodiment;

FIG. 5 is a left side view of the air cleaner of the embodiment; and

FIG. 6 is a cross-sectional view of the air cleaner and its surroundings in the embodiment.

### DESCRIPTION OF EMBODIMENTS

An air cleaner according to one aspect of the present disclosure is configured to be installed, together with an electrical component, below a seat of a saddle-type vehicle. An intake chamber is formed in a cleaner case of the air cleaner, and air is taken into the intake chamber through an intake pipe of the air cleaner. The cleaner case includes a support surface configured to support the electrical component from below. An intake port of the intake pipe is covered from above by the electrical component, whereby even when foreign matter such as water droplets or mud is stirred up by a rear wheel, it is possible to prevent intrusion of foreign matter from the intake port into the cleaner case. Furthermore, the electrical component is supported on the support surface of the cleaner case above the intake port, and there is no need to reduce a capacity of the cleaner case for storing the electrical component. Therefore, the electrical component and the air cleaner can be appropriately installed below the seat.

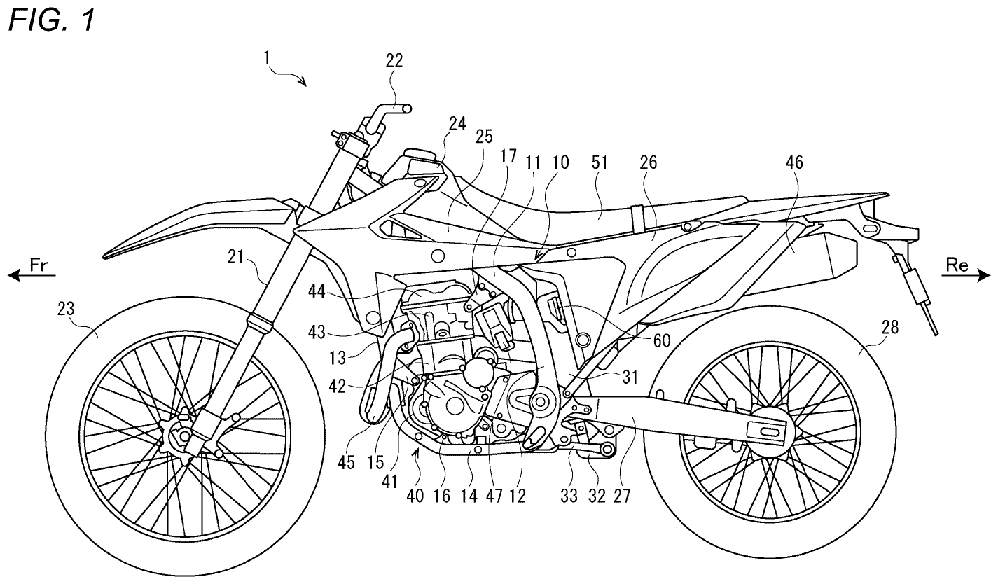

Hereinafter, a saddle-type vehicle provided with an air cleaner according to an embodiment will be described with reference to the accompanying drawings. FIG. 1 is a left side view of a saddle-type vehicle according to the this embodiment. In the following drawings, an arrow Fr indicates the front side of the vehicle, an arrow Re indicates the rear side of the vehicle, an arrow L indicates the left side of the vehicle, and an arrow R indicates the right side of the vehicle.

As illustrated in FIG. 1, a saddle-type vehicle 1 is configured by mounting various components such as an engine 40, an electrical system, and the like on a vehicle body frame 10. A pair of main frames 11 extend diagonally downward and rearward from a head pipe (not illustrated) of the vehicle body frame 10, and rear portions of the pair of main frames 11 are bent downward to form a pair of body frames 12. A down frame 13 extends downward from the head pipe, and an underloop 14 bent rearward is connected to a lower portion of the down frame 13. Rear ends of the pair of underloops 14 are connected to lower portions of the pair of body frames 12, so that the vehicle body frame 10 is formed into a cradle shape.

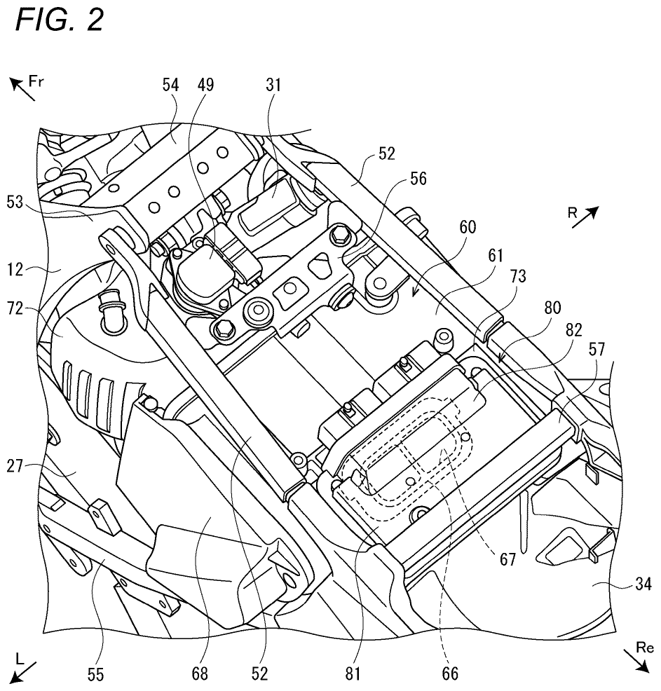

A front fork 21 is supported on the head pipe via a steering shaft (not illustrated) so as to be steerable. A handlebar 22 is provided on an upper portion of the front fork 21, and a front wheel 23 is rotatably supported on a lower portion of the front fork 21. A fuel tank 24 is placed on an upper portion of the pair of main frames 11, and the main frames 11 and the fuel tank 24 are covered from sides by front side covers 25. A seat 51 is provided behind the fuel tank 24, and upper seat rails (seat rails) 52 (see FIG. 2) that support the seat 51 from below are covered from sides by rear side covers 26.

A swing arm 27 is supported by the body frame 12 so as to be able to swing. The swing arm 27 extends rearward from the body frame 12, and a rear wheel 28 is rotatably supported at a rear end of the swing arm 27. A front side of the swing arm 27 and a lower portion of a rear suspension 31 are connected via a cushion lever 32. In addition, the cushion lever 32 and the body frame 12 are connected via a cushion rod 33. The rear suspension 31 expands and contracts in accordance with swing of the swing arm 27, thereby absorbing unevenness in the road surface, suppressing vibrations, and improving the contact between the rear wheel 28 and the road surface.

The engine 40 is a four-stroke single cylinder engine, and is suspended inside the vehicle body frame 10 via suspension brackets 15 to 17. A cylinder assembly, in which a cylinder 42, a cylinder head 43, and a cylinder head cover 44 are stacked, is attached to an upper portion of a crankcase 41 of the engine 40. An exhaust pipe 45 is connected to a front surface of the cylinder head 43. The exhaust pipe 45 passes through a right side of the cylinder 42 and extends rearward, and a muffler 46 of an up-type that is inclined obliquely upward toward the rear side is connected to an downstream end of the exhaust pipe 45. Further, an intake device such as an air cleaner 60 is provided behind the cylinder head 43.

Incidentally, in an off-road type saddle-type vehicle, electrical components such as an ECM and a Capacitive Discharge Ignition (CDI) are often installed under the seat. In recent years, saddle-type vehicles have become required to have advanced controls to improve engine performance, comply with exhaust gas regulations, and improve fuel efficiency, and are therefore equipped with a variety of sensors. Electrical components such as ECMs are becoming larger in size in order to control advanced controls and various sensors. In addition, the air cleaner is installed under the seat, and depending on a location of the electrical components, it may be necessary to reduce a capacity of the air cleaner or raise a seat height, lowering marketability.

An inlet pipe is provided in a cleaner case of the air cleaner, and air is taken into the cleaner case from an intake port of the inlet pipe. When the rear wheel kicks up foreign matter such as water droplets or mud while driving on rough terrain, the foreign matter may enter the cleaner case through the intake port of the inlet pipe. Therefore, in the saddle-type vehicle of this embodiment, the electrical components are stored in a gap between the seat and the air cleaner to maintain the capacity and marketability of the air cleaner, and the electrical components cover the intake port of the inlet pipe from above to prevent foreign matter from entering the cleaner case.

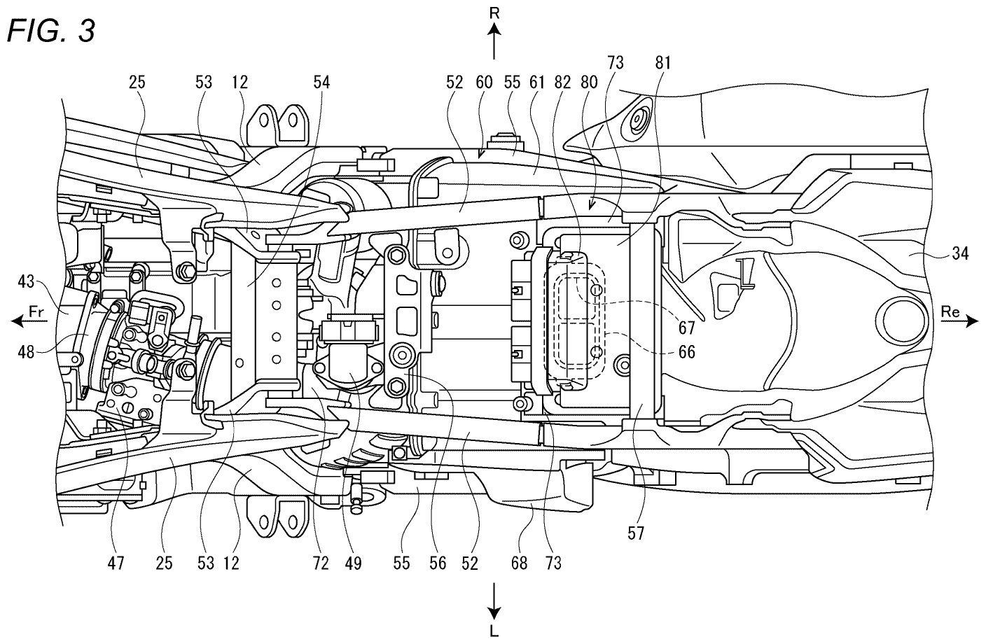

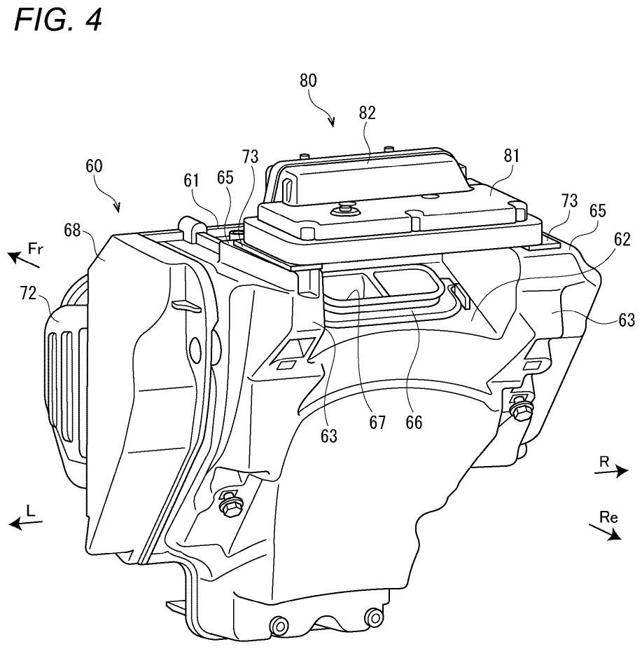

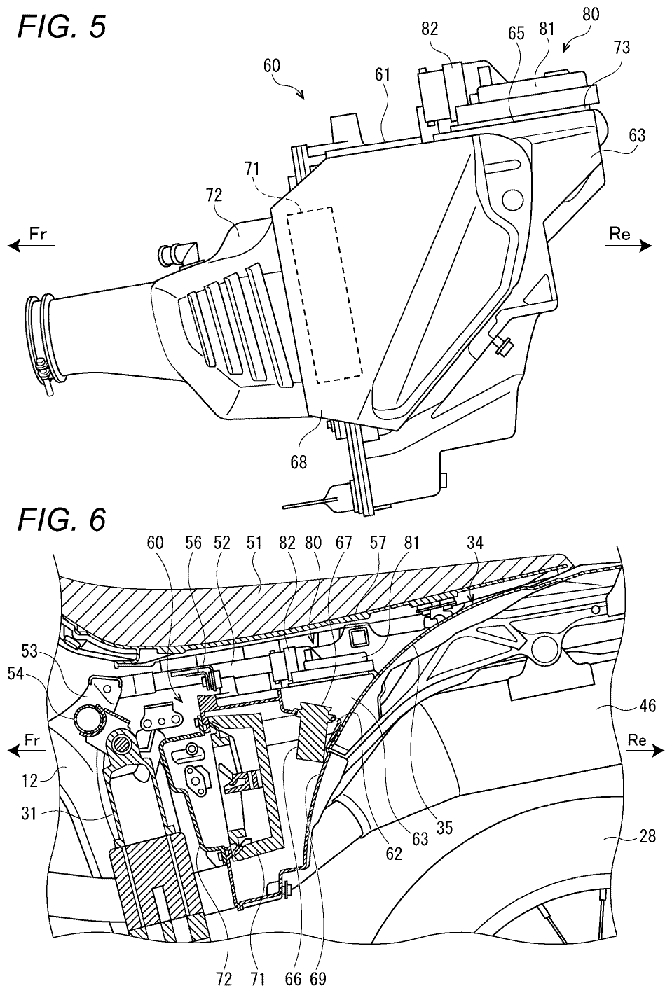

The air cleaner of this embodiment will be described with reference to FIGS. 2 to 5. FIG. 2 is a perspective view of the air cleaner and its periphery according to this embodiment. FIG. 3 is a top view of the air cleaner and its periphery according to this embodiment. FIG. 4 is a perspective view of the air cleaner of this embodiment. FIG. 5 is a left side view of the air cleaner of this embodiment. FIGS. 2 and 3 illustrate a state in which the seat is removed from the vehicle body frame.

As illustrated in FIGS. 2 and 3, upper portions of the pair of body frames 12 protrude obliquely upward and rearward, and a pair of protrusion portions 53 are connected via a frame bridge 54. A pair of upper seat rails 52 extend rearward from the pair of protrusion portions 53. Front ends of a pair of lower seat rails 55 are connected to lower portions of the pair of body frames 12, and the pair of lower seat rails 55 extend obliquely upward and rearward from lower portions of the pair of body frames 12. Rear ends of the pair of lower seat rails 55 are respectively connected to rear ends of the pair of upper seat rails 52.

Front portions of the pair of upper seat rails 52 are connected via a sensor bracket 56, and rear portions of the pair of upper seat rails 52 are connected via a seat bridge (bridge) 57. The sensor bracket 56 supports an accelerator position sensor 49 that is connected to an accelerator grip (not illustrated) via a cable. The air cleaner 60 is disposed in a space that is triangular when viewed from the side and surrounded by the body frame 12, the upper seat rail 52, and the lower seat rail 55 in a side view. An ECM 80 is disposed on the air cleaner 60 behind the sensor bracket 56 as an electrical component.

A rear dirty side of the air cleaner 60 is formed by a cleaner case 61, and a front clean side of the air cleaner 60 is formed by an outlet tube 72. An intake chamber 69 (see FIG. 6) is formed inside the cleaner case 61, and a filter 71 (see FIG. 5) is installed in the intake chamber 69. An inlet tube (intake pipe) 66 is provided on an upper rear surface of the cleaner case 61, and air is taken in from the inlet tube 66 into the intake chamber 69. Air taken into the intake chamber 69 through the inlet tube 66 is filtered by a filter 71 and sent to the outlet tube 72.

The outlet tube 72 is provided on a front surface of the cleaner case 61, and the outlet tube 72 is connected to a rear surface of the cylinder head 43 via electronically controlled throttle 47 and intake pipe 48. The outlet tube 72, the electronically controlled throttle 47, and the intake pipe 48 form a horizontal type intake passage. Air is sent from the outlet tube 72 to the electronically controlled throttle 47, and after an intake amount is adjusted by the electronically controlled throttle 47, the air is supplied from the electronically controlled throttle 47 to the cylinder head 43 through the intake pipe 48.

A rear fender 34 is attached to the rear surface of the air cleaner 60, so that even when foreign matter such as water droplets, mud or the like is stirred up by the rear wheel 28 (see FIG. 1), the rear fender 34 prevents the foreign matter from scattering toward the air cleaner 60. An intake port 67 of the inlet tube 66 is exposed from the upper rear surface of the cleaner case 61, and the intake port 67 is covered from above by the ECM 80 disposed on the upper surface of the cleaner case 61. The ECM 80 also functions as a hood for the inlet tube 66, and prevents foreign matter from entering the intake port 67 of the inlet tube 66.

As illustrated in FIGS. 4 and 5, the cleaner case 61 of the air cleaner 60 is formed in a box shape that is triangular when viewed from the side, and the outlet tube 72 is attached to the front surface of the cleaner case 61. As described above, the filter 71 is provided in the intake chamber 69 inside the cleaner case 61, and the intake chamber 69 of the cleaner case 61 is connected to an intake passage of the outlet tube 72 via the filter 71. A side cap 68 is detachably attached to an access window (not illustrated) on a left side surface of the cleaner case 61. The filter 71 can be replaced periodically by removing the side cap 68 from the cleaner case 61.

The cleaner case 61 includes a recess portion 62 formed in a center of the upper surface of a rear portion, and a pair of bulging walls 63. Front and both sides of the recess portion 62 are closed by wall surfaces, while the top and rear of the recess portion 62 are open. The inlet tube 66 is inserted into a bottom surface of the recess portion 62, and the intake port 67 of the inlet tube 66 faces upward. The pair of bulging walls 63 face each other across the recess portion 62, and upper surfaces of the pair of bulging walls 63 form a pair of support surfaces 65 that support the ECM 80 from below. The ECM 80 is formed in a rectangular shape when viewed from above, and both side portions of the ECM 80 are supported at both ends by the pair of support surfaces 65.

The pair of bulging walls 63 extend rearward beyond the intake port 67, and the pair of bulging walls 63 expand the intake chamber 69 of the cleaner case 61 rearward. The support surfaces 65 of the pair of bulging walls 63 are expanded to stably support the ECM 80, and the capacity of the air cleaner 60 is increased by the expansion of the intake chamber 69.

Furthermore, the ECM 80 is supported on the support surfaces 65 of the pair of bulging walls 63 via shock absorbing materials 73, and vibrations from the cleaner case 61 to the ECM 80 are absorbed by the shock absorbing materials 73. Since most of an upper part of the recess portion 62 is covered by the ECM 80, the ECM 80 prevents foreign matter from entering the intake port 67 from above.

The ECM 80 includes a plate-shaped case 81 having a thin, rectangular shape, and a connector 82 that protrudes from an upper surface of the plate-shaped case 81. A circuit board is stored inside the plate-shaped case 81, and various electronic components such as a processor and a memory are mounted on the circuit board. The connector 82 is provided along a front edge of the plate-shaped case 81, and a harness (not illustrated) extending from an external device is connected to the connector 82. The intake port 67 of the inlet tube 66 is located below the ECM 80, and the air flows into the intake port 67 and hits the plate-shaped case 81, thereby efficiently cooling the ECM 80.

A layout of the air cleaner and the ECM will be described with reference to FIGS. 3 and 6. FIG. 6 is a cross-sectional view of the air cleaner and its surroundings in this embodiment.

As illustrated in FIG. 6, the air cleaner 60 and the ECM 80 are provided below the seat 51. The upper seat rail 52 extends rearward from the protrusion portion 53 of the body frame 12, and the upper seat rail 52 supports the seat 51 from below. The air cleaner 60 is positioned below the upper seat rail 52. The ECM 80 is supported on the rear upper surface of the air cleaner 60, and the connector 82 of the ECM 80 is positioned at approximately the same height as the upper seat rail 52. In this manner, the ECM 80 having a thin thickness is installed in a narrow space between the seat 51 and the air cleaner 60.

As illustrated in FIGS. 3 and 6, the ECM 80 is supported by the pair of bulging walls 63 of the cleaner case 61, and the inlet tube 66 is provided in the recess portion 62 between the pair of bulging walls 63. Even when the ECM 80 is provided in the cleaner case 61, the inlet tube 66 does not interfere with the ECM 80, and the effect on the seat height is suppressed. In addition, the capacity of the air cleaner 60 is ensured by the pair of bulging walls 63. A projected area of the ECM 80 in a top view is larger than an opening area of the intake port 67, and the entirety of the intake port 67 is covered from above by the ECM 80, so that the ECM 80 effectively prevents foreign matter from entering the intake port 67.

A distance between the pair of upper seat rails 52 gradually increases rearward from the upper portions of the pair of body frames 12. At a position where a driver straddles the seat 51, the distance between the pair of upper seat rails 52 is narrower than a width of the ECM 80, improving the driver's ability to reach the ground with his or her feet when straddling the seat 51. At an installation position of the ECM 80, the distance between the pair of upper seat rails 52 is wider than the width of the ECM 80, and the capacity of the air cleaner 60 that supports the ECM 80 from below is sufficiently ensured. The ECM 80 is positioned inside the pair of upper seat rails 52 and is thereby protected by the pair of upper seat rails 52.

The bottom surface of the recess portion 62 is inclined so as to become gradually lower toward the rear side, and the lower surface of the ECM 80 is inclined so as to become gradually higher toward the rear side. That is, the bottom surface of the recess portion 62 is inclined so that a distance between the bottom surface of the recess portion 62 and the lower surface of the ECM 80 gradually increases toward the rear side. As a result, even when the ECM 80 is installed on the upper surface of the air cleaner 60 and covers the upper part of the intake port 67, an appropriate distance is maintained between the ECM 80 and the intake port 67, allowing smooth intake of air. The rear fender 34 is attached to the rear portion of the cleaner case 61, and the rear surface of the cleaner case 61 is curved so as to be continuous with a curved surface 35 of the rear fender 34.

The intake port 67 of the inlet tube 66 and the ECM 80 on the cleaner case 61 are covered from the rear side by the curved surface 35 of the rear fender 34. A gap is provided between a rear edge of the ECM 80 and the curved surface 35 of the rear fender 34, and a gap is provided between a front edge of the ECM 80 and a front edge of the recess portion 62, and air is taken in through these gaps into the intake port 67. The rear side of the recess portion 62 of the cleaner case 61 is covered by the rear fender 34, thereby preventing foreign matter from entering the intake port 67 from behind the recess portion 62. In addition, an entry path of foreign matter is narrowed by the gaps on the front side and on the rear side of the ECM 80, so that the entry of foreign matter from above the recess portion 62 into the intake port 67 is suppressed.

The pair of upper seat rails 52 are connected via the seat bridge 57, and the ECM 80 on the cleaner case 61 is located to enter below the seat bridge 57. The rear side of the ECM 80 is formed only by the plate-shaped case 81 having a thin thickness, and the plate-shaped case 81 is fitted between the seat bridge 57 and the cleaner case 61. The seat bridge 57 restricts the bending of the seat 51 and suppresses interference between the ECM 80 and the seat bridge 57, so that the seat 51 and the air cleaner 60 are brought closer to each other and a seat height is suppressed. Furthermore, the seat 51 improves protection performance for the air cleaner 60 and the ECM 80.

As described above, according to the air cleaner 60 of this embodiment, the intake port 67 of the inlet tube 66 is covered by the ECM 80, so that even when foreign matter such as water droplets or mud is stirred up by the rear wheel 28, it is possible to prevent the intrusion of foreign matter from the intake port 67 into the cleaner case 61. The ECM 80 is supported on the support surface 65 of the cleaner case 61 above the intake port 67, and there is no need to reduce the capacity of the cleaner case 61 in order to store the ECM 80. Therefore, the ECM 80 and the air cleaner 60 can be appropriately installed below the seat 51.

In this embodiment, an ECM is exemplified as an electrical component, but the electrical component may be another electrical component such as a CDI.

Also, in this embodiment, the ECM is disposed below the seat bridge, but the ECM may be positioned on the front side relative to the seat bridge. In this case, it is preferable for the ECM to be positioned lower than the seat bridge.

Furthermore, in this embodiment, the entirety of the intake port of the inlet tube is covered from above by the ECM, but it is sufficient that at least a part of the intake port of the inlet tube is covered from above by the ECM.

In addition, in this embodiment, the recess portion and the pair of bulging walls are formed at the rear portion of the cleaner case, the inlet tube is provided in the recess portion, and the ECM is supported by the pair of bulging walls, but the shape of the cleaner case is not particularly limited. The cleaner case may have a support surface that supports the electrical components so as to cover the intake port of the inlet tube.

Furthermore, the air cleaner of this embodiment is not limited to the above-described saddle-type vehicle, but may be adopted in other types of saddle-type vehicles. A saddle-type vehicle is not limited to all vehicles in which a driver sits astride a seat, but also includes scooter-type vehicles in which a rider does not sit astride a seat.

As described above, in a first aspect, there is provided an air cleaner (60) configured to be installed, together with an electrical component (ECM 80), below a seat (51) of a saddle-type vehicle (1), the air cleaner including: a cleaner case (61) including an intake chamber (69) formed therein; and an intake pipe (inlet tube 66) configured to take in air into the intake chamber, in which: the cleaner case includes a support surface (65) configured to support the electrical component from below; and an intake port (67) of the intake pipe is covered from above by the electrical component. According to this configuration, the intake port of the intake pipe is covered by the electrical component, whereby even when foreign matter such as water droplets or mud is stirred up by a rear wheel, it is possible to prevent intrusion of foreign matter from the intake port into the cleaner case. The electrical component is supported on the support surface of the cleaner case above the intake port, and there is no need to reduce a capacity of the cleaner case for storing the electrical component. Therefore, the electrical component and the air cleaner can be appropriately installed below the seat.

In a second aspect, there is provided the air cleaner (60) according to the first aspect, in which a projected area of the electrical component in a top view is larger than an opening area of the intake port, and an entirety of the intake port is covered from above by the electrical component. According to this configuration, the intake port of the intake pipe is entirely covered by the electrical component, whereby intrusion of foreign matter into the intake port is more effectively prevented.

In a third aspect, there is provided the air cleaner (60) according to the first or second aspect, in which: a rear portion of the cleaner case is recessed to form a recess portion (62) and a pair of bulging walls (63) interposing the recess portion; and the intake pipe is provided on a bottom surface of the recess portion, and each of upper surfaces of the pair of bulging walls serves as the support surface. According to this configuration, even when the electrical component is provided in the cleaner case, the intake pipe does not interfere with the electrical component, and the effect on the seat height is reduced. Furthermore, the pair of bulging walls support the electrical component while ensuring the capacity of the air cleaner.

In a fourth aspect, there is provided the air cleaner (60) according to the third aspect, in which: the pair of bulging walls extend rearward beyond the intake port. According to this configuration, the pair of bulging walls extend rearward, thereby widening the support surface and stably supporting the electrical component, and the intake chamber is expanded rearward, increasing the capacity of the air cleaner.

In a fifth aspect, there is provided the air cleaner (60) according to the third or fourth aspect, in which: a rear side of the recess portion is open; and the bottom surface of the recess portion is inclined such that a distance between the bottom surface of the recess portion and a lower surface of the electrical component becomes gradually larger toward the rear side. According to this configuration, even when the upper part of the intake port is covered with electrical component, an appropriate distance is maintained between the intake port and the electrical component, allowing air to be smoothly drawn in.

In a sixth aspect, there is provided the air cleaner (60) according to the fifth aspect, in which: a rear fender (34) is attached to the cleaner case; and the intake port is covered by the rear fender from the rear side. According to this configuration, the rear side of the recess portion is covered by the rear fender, thereby preventing foreign matter from entering the intake port from behind the recess portion.

In a seventh aspect, there is provided the air cleaner (60) according to the sixth aspect, in which: the electrical component on the cleaner case is covered from the rear side by the rear fender; and a gap is provided between the electrical component and the rear fender, and the air is taken in through the gap into the intake port. According to this configuration, an entry path of foreign matter is narrowed by the gap between the electrical component and the rear fender, whereby the entry of foreign matter from above the recess portion into the intake port is suppressed.

In an eighth aspect, there is provided the air cleaner (60) according to any one of the first to seventh aspects, in which: the seat is supported from below by a pair of seat rails (upper seat rails 52), the pair of seat rails being connected via a bridge (seat bridge 57); and the electrical component on the cleaner case is located to enter below the bridge. According to this configuration, the bridge restricts bending of the seat and reduces interference between the bridge and the electrical component, whereby the seat and the air cleaner can be brought closer together and the seat height can be reduced. The seat also provides improved protection for the air cleaner and electrical component.

Although this embodiment is described, other embodiments may be made by combining the above-described embodiment and modification examples in whole or in part.

Furthermore, the technology of the present disclosure is not limited to the above-described embodiment, and may be modified, substituted, or changed in various ways without departing from the spirit and scope of the technical idea. Furthermore, when technological advances or derived technologies allow the technical ideas to be realized in a different way, they may be implemented using that method. Therefore, the claims cover all embodiments that may fall within the scope of the technical concept.

What is claimed is:

1. An air cleaner configured to be installed, together with an electrical component, below a seat of a saddle-type vehicle, the air cleaner comprising:
a cleaner case comprising an intake chamber formed therein; and
an intake pipe configured to take in air into the intake chamber,
wherein the cleaner case comprises a support surface configured to support the electrical component from below, and
wherein an intake port of the intake pipe is covered from above by the electrical component.

2. The air cleaner according to claim 1,
wherein a projected area of the electrical component in a top view is larger than an opening area of the intake port, and an entirety of the intake port is covered from above by the electrical component.

3. The air cleaner according to claim 1,
wherein a rear portion of the cleaner case is recessed to form a recess portion and a pair of bulging walls interposing the recess portion, and
wherein the intake pipe is provided on a bottom surface of the recess portion, and each of upper surfaces of the pair of bulging walls serves as the support surface.

4. The air cleaner according to claim 3, wherein the pair of bulging walls extend rearward beyond the intake port.

5. The air cleaner according to claim 3,
wherein a rear side of the recess portion is open, and
wherein the bottom surface of the recess portion is inclined such that a distance between the bottom surface of the recess portion and a lower surface of the electrical component becomes gradually larger toward the rear side.

6. The air cleaner according to claim 5,
wherein a rear fender is attached to the cleaner case, and
wherein the intake port is covered by the rear fender from the rear side.

7. The air cleaner according to claim 6,
wherein the electrical component on the cleaner case is covered from the rear side by the rear fender, and
wherein a gap is provided between the electrical component and the rear fender, and the air is taken in through the gap into the intake port.

8. The air cleaner according to claim 1,
wherein the seat is supported from below by a pair of seat rails, the pair of seat rails being connected via a bridge, and
wherein the electrical component on the cleaner case is located to enter below the bridge.
